(19) United States
(12) Patent Application Publication
(10) Pub. No.: US 2021/0278229 A1
(43) Pub. Date: Sep. 9, 2021

(54) TRAVELABLE DISTANCE DISPLAY APPARATUS

(71) Applicant: HONDA MOTOR CO., LTD., Tokyo (JP)

(72) Inventor: Shuichi KAZUNO, Saitama (JP)

(21) Appl. No.: 17/182,245

(22) Filed: Feb. 23, 2021

(30) Foreign Application Priority Data
Mar. 3, 2020 (JP) 2020-036154

(51) Int. Cl. G01C 21/34; B60W 40/09

(52) U.S. Cl. CPC G01C 21/3469; B60W 2530/14; B60W 40/09; G01C 21/3484

(57) ABSTRACT

Provided is a travelable distance display apparatus that can accurately estimate a travelable distance of an electric vehicle and display the travelable distance according to the state of use of the electric vehicle.

A travelable distance display apparatus 60 mounted on an electric vehicle 10 having a battery 40 for supplying travel power includes a travelable distance calculation device 62 and a display device 65. The travelable distance calculation device 62 calculates a travelable distance of the electric vehicle 10 based on the average speed of the electric vehicle 10 and the power consumption of an air-conditioning apparatus 80 mounted on the electric vehicle 10. The display device 65 can display the travelable distance of the electric vehicle 10 in a case where each of the average speed of the electric vehicle 10 and use/non-use of the air-conditioning apparatus 80 is changed.

This application is based on and claims the benefit of priority from Japanese Patent Application No. 2020-036154, filed on 3 Mar. 2020, the content of which is incorporated herein by reference.

### BACKGROUND OF THE INVENTION

### Field of the Invention

The present invention relates to a travelable distance display apparatus.

### Related Art

Typically, an electric vehicle travelling by using drive force of a motor, such as an electric automobile or a hybrid automobile, has been known.

The electric vehicle travels in such a manner that power of a mounted battery is transmitted to the motor to drive the motor.
Thus, there are needs that a travelable distance of the electric vehicle is accurately grasped by a technique equivalent to a fuel meter of a typical gasoline automobile.
Thus, a technique relating to estimation of the travelable distance of the electric vehicle has been known (e.g., Japanese Unexamined Patent Application, Publication No. 2014-000942).

Patent Document 1: Japanese Unexamined Patent Application, Publication No. 2014-000942

### SUMMARY OF THE INVENTION

The technique disclosed in Japanese Unexamined Patent Application, Publication No. 2014-000942 fails to specifically disclose a travelable distance estimation method taking an air-conditioning apparatus with a great power consumption amount among equipment of the electric vehicle into consideration of estimation of the travelable distance.

Moreover, the way to display the estimated travelable distance for a user of the electric vehicle is not taken into consideration.

The present invention has been made in view of the above-described situation, and an object thereof is to provide a travelable distance display apparatus that can accurately estimate a travelable distance of an electric vehicle and can display the travelable distance according to the state of use of the electric vehicle.

(1) The present invention relates to a travelable distance display apparatus mounted on an electric vehicle having a secondary battery for supplying travel power, the travelable distance display apparatus including a travelable distance calculation device and a display device. The travelable distance calculation device calculates a travelable distance of the electric vehicle based on the average speed of the electric vehicle and the power consumption of an air-conditioning apparatus mounted on the electric vehicle. The display device can display the travelable distance of the electric vehicle in a case where each of the average speed of the electric vehicle and use/non-use of the air-conditioning apparatus is changed.

According to the aspect (1) of the invention, the travelable distance display apparatus is provided, which can accurately estimate the travelable distance of the electric vehicle and can display the travelable distance according to the state of use of the electric vehicle.

(2) The travelable distance display apparatus according to (1), further including a correction device that corrects the travelable distance calculated by the travelable distance calculation device. The correction device can acquire path information on the electric vehicle, and corrects the travelable distance based on the path information.

According to the aspect (2) of the invention, the correction device corrects the travelable distance based on the electric vehicle path information, and therefore, the travelable distance of the electric vehicle can be more accurately estimated.

(3) The travelable distance display apparatus according to (1) or (2), further including a display control device that controls display of the travelable distance on the display device. The display control device performs such control that the travelable distance and a remaining secondary battery level warning are displayed together on the display device.

According to the aspect (3) of the invention, the display control device displays the travelable distance of the electric vehicle together with the remaining secondary battery level warning, and therefore, convenience of a user of the electric vehicle can be enhanced.

### BRIEF DESCRIPTION OF THE DRAWINGS

FIG. 1 is a diagram for describing an electric vehicle on which a display apparatus according to the present embodiment is mounted;

FIG. 2 is a view for describing, as an example, a configuration in a vehicle compartment of the electric vehicle according to the present embodiment;

FIG. 3 is a diagram for describing a configuration of a display apparatus according to the present embodiment;

FIG. 4 is a graph showing data calculated by a travelable distance calculation device according to the present embodiment; and

FIG. 5 is a view showing contents displayed on a display device of the display apparatus according to the present embodiment.

### DETAILED DESCRIPTION OF THE INVENTION

### Electric Vehicle

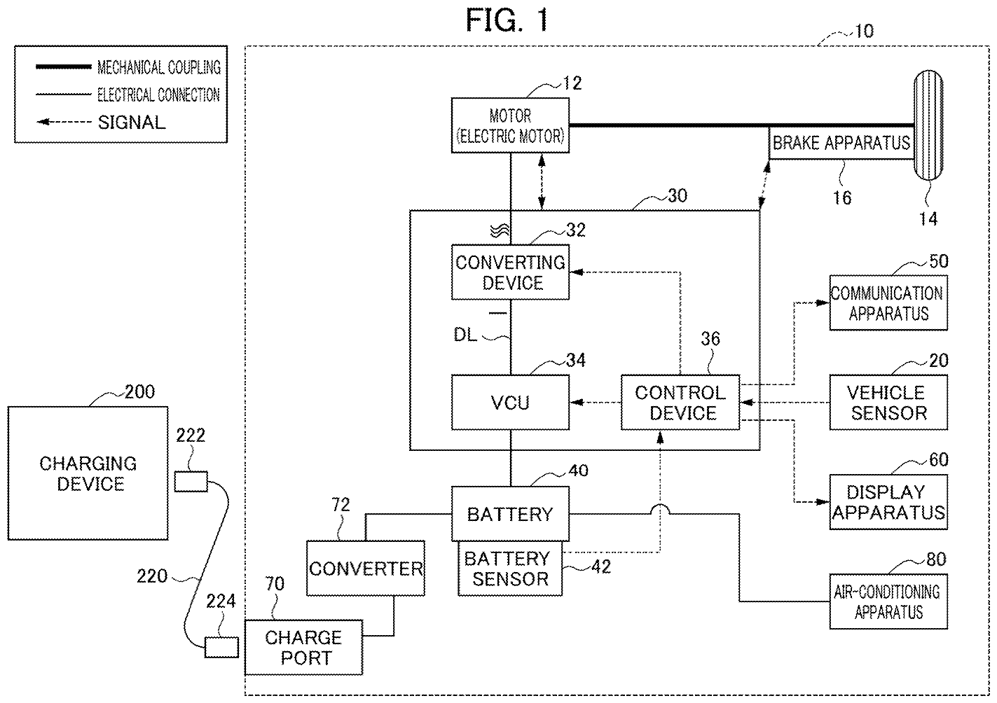

FIG. 1 is a diagram showing a configuration of an electric vehicle 10 on which a travelable distance display apparatus 60 according to one embodiment of the present invention is mounted. As shown in FIG. 1, the electric vehicle 10 is, for example, an electric automobile or a hybrid electric automobile that travels by travel power supplied from a battery 40 as a secondary battery.

In the electric vehicle 10, the battery 40 is charged by charge control of a charge control device 210 provided at a charging device 200 in such a manner that a plug 222 provided at one end of a charge cable 220 is connected to the charging device 200 and a plug 224 provided at the other end of the charge cable 220 is connected to a charge port 70 provided outside a vehicle body of the electric vehicle 10.
Note that instead of connection via the charge cable 220, the electric vehicle 10 can be also broadly applied to a non-contact charge configuration and a charge configuration using power of, e.g., an internal combustion engine or a fuel battery provided in the electric vehicle 10.

The electric vehicle 10 includes, for example, a motor 12, a drive wheel 14, a brake apparatus 16, a vehicle sensor 20, a power control unit (PCU) 30, the battery 40 as the secondary battery, a battery sensor 42, the display apparatus 60, the charge port 70, a converter 72, and an air-conditioning apparatus 80.

The motor 12 is, for example, a three-phase AC motor.

The motor 12 has a rotor coupled to the drive wheel 14 such that the drive wheel 14 is driven by supplied power. Upon deceleration, the motor 12 generates power by rotation energy of the drive wheel 14 to output the power.

The brake apparatus 16 includes, for example, a brake caliper, a cylinder that transmits a hydraulic pressure to the brake caliper, and an electric motor that generates the hydraulic pressure at the cylinder.

The brake apparatus 16 may include, as a backup, a mechanism that transmits a hydraulic pressure generated by operation of a brake pedal to the cylinder via a master cylinder.
Note that the brake apparatus 16 is not limited to the above-described configuration, and may be an electronic control hydraulic brake apparatus that transmits a hydraulic pressure of the master cylinder to the cylinder.

The vehicle sensor 20 includes an accelerator opening degree sensor, a vehicle speed sensor, and a brake stepping amount sensor. The accelerator opening degree sensor is attached to an accelerator pedal as one example of an operator that receives a driver's acceleration instruction, and detects the amount of operation of the accelerator pedal to output such an operation amount as an accelerator opening degree to a control device 36.

The vehicle speed sensor includes, for example, a vehicle wheel speed sensor attached to each wheel and a speed calculation device, and integrates the vehicle wheel speeds detected by the vehicle wheel speed sensors to derive the speed (a vehicle speed) of the vehicle and outputs the vehicle speed to the control device 36 and the display apparatus 60.
The brake stepping amount sensor is attached to the brake pedal, and detects the amount of operation of the brake pedal to output such an operation amount as a brake stepping amount to the control device 36.

The PCU 30 includes, for example, a converting device 32, a voltage control unit (VCU) 34, and the control device 36.

Note that these components are not necessarily integrated as the PCU 30, and may be dispersively arranged.

The converting device 32 is, for example, an AC-DC converting device.

A DC-side terminal of the converting device 32 is connected to a DC link DL.
The battery 40 is connected to the DC link DL via the VCU 34.
Upon deceleration, the converting device 32 converts AC power generated by the motor 12 into DC power to output the DC power to the DC link DL.
Conversely, upon drive of the motor 12, the converting device 32 converts DC power output from the VCU 34 via the DC link DL into AC power to output the AC power to the motor 12.

The VCU 34 is, for example, a DC-DC converter.

Upon drive of the motor 12, the VCU 34 boosts power supplied from the battery 40 to output the power to the DC link DL. Conversely, upon deceleration, the VCU 34 outputs, with a predetermined voltage, power output from the DC link DL to the battery 40.

The control device 36 includes, for example, a motor control device, a brake control device, and a secondary battery/VCU control device.

The motor control device, the brake control device, and the secondary battery/VCU control device may be replaced with separate control apparatuses such as a motor ECU, a brake ECU, and a secondary battery ECU.

The motor control device controls the motor 12 based on the output of the vehicle sensor 20.

The brake control device controls the brake apparatus 16 based on the output of the vehicle sensor 20.
The secondary battery/VCU control device calculates the state of charge (SOC; a secondary battery charge rate) of the battery 40 based on the output of the battery sensor 42 attached to the battery 40, thereby outputting the SOC to the VCU 34 and the display apparatus 60. The VCU 34 boosts the voltage of the DC link DL according to an instruction from the secondary battery/VCU control device.

The battery 40 as the secondary battery is, for example, a secondary battery such as a lithium-ion battery.

The battery 40 accumulates power supplied from the charging device 200 outside the electric vehicle 10 to output the accumulated power for travelling of the electric vehicle 10.
Upon deceleration, the battery 40 accumulates power output from the VCU 34.
The battery sensor 42 includes, for example, a current sensor, a voltage sensor, and a temperature sensor.
The battery sensor 42 detects, for example, the current value, voltage value, and temperature of the battery 40.
The battery sensor 42 outputs, e.g., the detected current value, voltage value, and temperature to the control device 36 and the display apparatus 60.

A communication apparatus 50 includes a wireless module for connecting a cellular network or a Wi-Fi network.

The communication apparatus 50 communicates with, e.g., a not-shown server via a network such as the Internet.

The display apparatus 60 is the travelable distance display apparatus that displays a travelable distance of the electric vehicle 10.

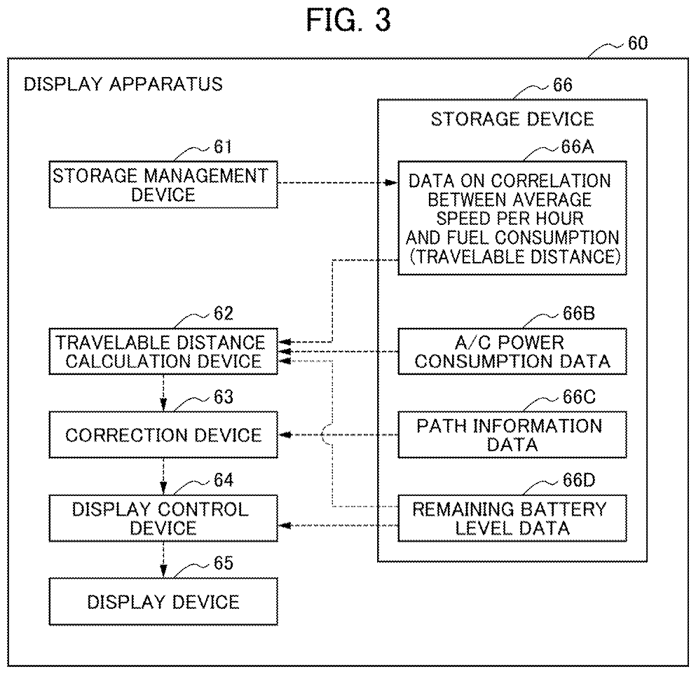

The display apparatus 60 estimates the travelable distance of the electric vehicle 10 based on, e.g., the state of charge (SOC; the secondary battery charge rate) of the battery 40 calculated by the control device 36, the average speed of the electric vehicle 10, and the power consumption of the air-conditioning apparatus 80, and displays the travelable distance on a display device 65.
Details of the display apparatus 60 will be described later with reference to FIG. 3.

The converter 72 is provided between the battery 40 and the charge port 70.

The converter 72 converts AC power introduced from the charging device 200 via the charge port 70 into DC power to output the DC power to the battery 40.

The air-conditioning apparatus 80 is an apparatus that performs air-conditioning in a vehicle compartment of the electric vehicle 10. The air-conditioning apparatus 80 includes, for example, a refrigerant circuit in which refrigerant circulates, a compressor that compresses and discharges refrigerant, an outdoor heat exchanger that exchanges heat between refrigerant and external air, and a blower that sends out air (any of these components is not shown in the figure).

The air-conditioning apparatus 80 operates by consuming power supplied from the battery 40.
Data on the power consumption of the air-conditioning apparatus 80 is transmitted to the control device 36 via the battery sensor 42.

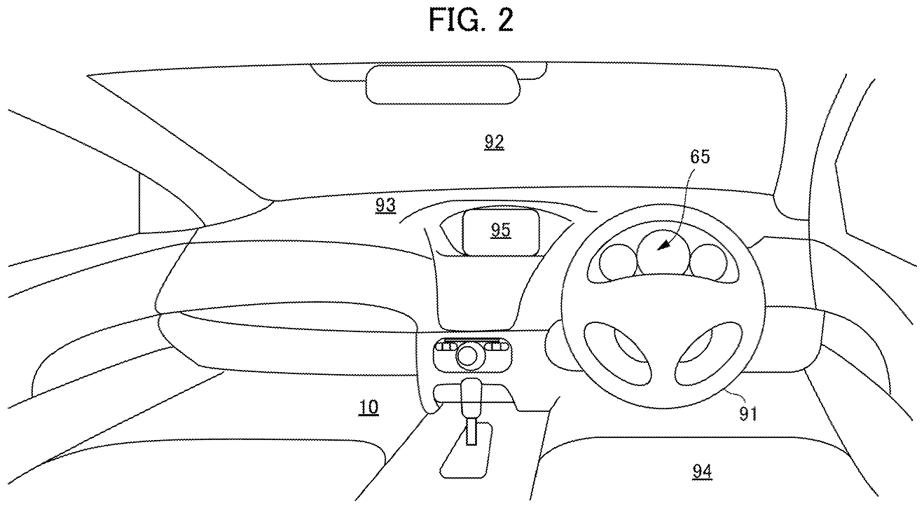

FIG. 2 is a view for describing, as an example, a configuration in the vehicle compartment of the electric vehicle 10.

As illustrated in FIG. 2, the electric vehicle 10 is, for example, provided with a steering wheel 91 that controls steering of the electric vehicle 10, a front window shield 92 that separates the outside of the vehicle and the inside of the vehicle compartment, and an instrument panel 93.
The front window shield 92 is a member having optical transparency.

The display device 65 of the display apparatus 60 is provided in the vicinity of the front of a driver seat 94 at the instrument panel 93 in the vehicle compartment.

The display device 65 is arranged so that the driver can view the display device 65 through a clearance of the steering wheel 91 or over the steering wheel 91.
A second display apparatus 95 different from the display apparatus 60 is provided at the center of the instrument panel 93.

The second display apparatus 95 displays, e.g., an image corresponding to navigation processing executed by a navigation apparatus (not shown) mounted on the electric vehicle 10, or displays, e.g., video of a partner in videotelephony.

The second display apparatus 95 may display contents such as a TV program, video of a DVD, or a downloaded movie.

### Travelable Distance Display Apparatus

Next, details of a configuration of the display apparatus 60 will be described.

FIG. 3 is a diagram showing one example of the configuration of the display apparatus 60.
The display apparatus 60 includes, for example, a storage management device 61, a travelable distance calculation device 62, a correction device 63, a display control device 64, the display device 65, and a storage device 66.
The display apparatus 60 executes a program of the display apparatus 60 by a built-in arithmetic processing circuit, thereby executing a series of procedures.

Some or all of the above-described components of the display apparatus 60 may be implemented by hardware (a circuit device; including a circuitry) such as a large scale integration (LSI), an application specific integrated circuit (ASIC), a field-programmable gate array (FPGA), or a graphics processing unit (GPU), or may be implemented by cooperation of software and hardware.

The storage management device 61 stores, in the storage device 66, the SOC of the battery 40 and the average speed of the electric vehicle 10 per hour.

For example, the storage management device 61 may store, in the storage device 66, the SOC of the battery 40 and the average speed of the electric vehicle 10 per hour in every certain time.
Based on the above-described stored data, data 66A on correlation between the average speed per hour and a fuel consumption (a power consumption amount).
The data 66A may be data produced in advance based on, e.g., a test result.

The travelable distance calculation device (hereinafter sometimes merely referred to as a “calculation device”) 62 calculates the travelable distance of the electric vehicle 10 based on the data 66A on the correlation between the average speed per hour and the fuel consumption, air-conditioning apparatus power consumption data 66B, and remaining battery level data 66D, the data 66A, 66B, 66D being stored in the storage device 66.

For example, based on the amount ΔC, which corresponds to the data 66A, of change in the SOC over time T, an average fuel consumption Acost (km/Wh) at the average speed v per hour is calculated by Expression (1) below.

Acost(km/Wh)=v(km/h)×T(h)/ΔC(Wh) (1)

The calculation device 62 calculates the travelable distance of the electric vehicle 10 from the average fuel consumption Acost at the average speed v per hour.

For example, based on the remaining battery level C1 of the battery 40 corresponding to the data 66D, a travelable distance L is calculated by Expression (2) below.

Travelable Distance L(km)=C1(Wh)/Acost(km/Wh) (1)

Similarly, the calculation device 62 calculates a travelable distance L1 by Expression (3) below, considering a power consumption E corresponding to the data 66B in the case of using the air-conditioning apparatus 80.

Travelable Distance L1(km)=C1(Wh)−E(Wh)/Acost(km/Wh) (3)

Further, the calculation device 62 calculates, for each average speed per hour, the travelable distances L, L1 in a case where the average speed v of the electric vehicle 10 per hour is changed.

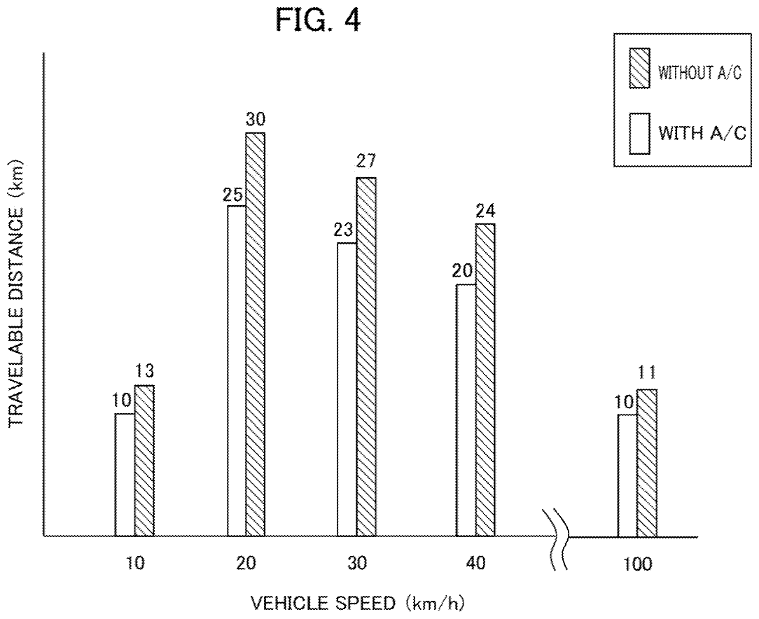

FIG. 4 is a graph showing the travelable distances L, L2 calculated by the calculation device 62.
In FIG. 4, the vertical axis indicates the travelable distance (km), and the horizontal axis indicates the average speed (km/h) of the electric vehicle 10.
Of adjacent bar graphs, the left bar graph indicates the travelable distance without use of the air-conditioning apparatus 80, and the right bar graph indicates the travelable distance with use of the air-conditioning apparatus 80.
As shown in FIG. 4, the calculation device 62 calculates the travelable distance of the electric vehicle 10 for each average speed per hour according to use/non-use of the air-conditioning apparatus 80.

The correction device 63 corrects the travelable distance of the electric vehicle 10 calculated by the calculation device 62.

The correction device 63 corrects the travelable distance of the electric vehicle 10 based on path information data 66C on the electric vehicle 10, the path information data 66C being saved in the storage device 66.
The path information data 66C includes, for example, data on a scheduled travel path of the electric vehicle 10 to a destination and data on an average vehicle speed on the scheduled travel path.
The average vehicle speed data is, for example, obtained in such a manner that data on the travel speed of the vehicle travelling on the scheduled travel path is transmitted to a cloud server in real time and is calculated as the average vehicle speed on the cloud.
In addition to the above-described data, the path information data 66C may include, for example, the value of power expected to be lost due to deceleration and stop of the vehicle due to, e.g., a traffic light or a traffic jam.

The display control device 64 controls display of the travelable distances L, L1 of the electric vehicle 10 calculated by the calculation device 62 on the display device 65.

For example, the display control device 64 displays a remaining level warning on the display device 65 in a case where the remaining level of the battery 40 reaches equal to or less than a certain value. Moreover, the display control device 64 controls display on the display device 65 such that the travelable distances L, L1 are displayed together with the remaining level warning.
With this configuration, the travelable distances L, L1 are displayed only in a situation highly needing these distances, and therefore, convenience of the display apparatus 60 can be improved.

The display device 65 displays the travel speed of the electric vehicle 10 output from the vehicle sensor 20.

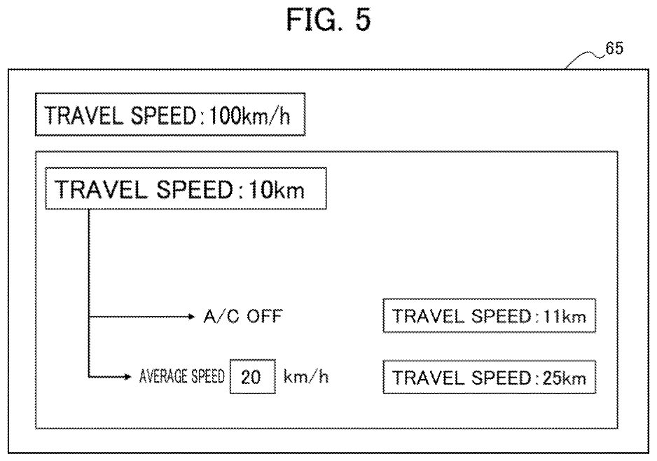

Moreover, the display device 65 displays the travelable distances L, L1 of the electric vehicle 10 calculated by the calculation device 62. FIG. 5 is a view showing one example of contents displayed on the display device 65.
As shown in FIG. 5, the current travel speed of the electric vehicle 10 such as 100 km/h and the travelable distance in a case where travelling is continued at such a speed are displayed on the display device 65.
Moreover, on the display device 65, the travelable distance in a case where the travel speed is changed to decrease to, e.g., 20 km/h and the travelable distance in a case where the air-conditioning apparatus 80 is turned off are also displayed.
With this configuration a user performs, e.g., the operation of decreasing the travel speed of the electric vehicle 10 or switching use of the air-conditioning apparatus 80 in a case where the remaining capacity of the battery 40 has decreased, and therefore, can arrive at the destination.
Note that the travelable distance can be displayed to change in increments of, e.g., 10 km/h, as necessary.
This can further improve convenience of the user because a speed limit on a public road is set in increments of, e.g., 10 km/h in many cases.

The storage device 66 stores and saves data such as the data 66A on the correlation between the average speed per hour and the fuel consumption, the air-conditioning apparatus power consumption data 66B, the path information data 66C, and the remaining battery level data 66D.

The preferred embodiment of the present invention has been described above, but the present invention is not limited to the above-described embodiment and those changed as necessary are also included in the scope of the present invention.

### EXPLANATION OF REFERENCE NUMERALS

10 Electric Vehicle
40 Battery (Secondary Battery)
60 Display Apparatus (Travelable Distance Display Apparatus)
62 Travelable Distance Calculation Device
63 Correction Device
64 Display Control Device
65 Display Device
80 Air-Conditioning Apparatus

What is claimed is:

1. A travelable distance display apparatus mounted on an electric vehicle having a secondary battery for supplying travel power, comprising:
a travelable distance calculation device; and
a display device,
wherein the travelable distance calculation device calculates a travelable distance of the electric vehicle based on an average speed of the electric vehicle and a power consumption of an air-conditioning apparatus mounted on the electric vehicle, and
the display device is able to display the travelable distance of the electric vehicle in a case where each of the average speed of the electric vehicle and use/non-use of the air-conditioning apparatus is changed.

2. The travelable distance display apparatus according to claim 1, further comprising:
a correction device that corrects the travelable distance calculated by the travelable distance calculation device,
wherein the correction device is able to acquire path information on the electric vehicle, and corrects the travelable distance based on the path information.

3. The travelable distance display apparatus according to claim 1, further comprising:
a display control device that controls display of the travelable distance on the display device,
wherein the display control device performs such control that the travelable distance and a remaining secondary battery level warning are displayed together on the display device.
